(19) United States
(12) Patent Application Publication
(10) Pub. No.: US 2011/0245392 A1
(43) Pub. Date: Oct. 6, 2011

(54) SILANE-MODIFIED NANOPARTICLES MADE OF METAL OXIDES

(75) Inventors: Andrey Karpov, Mannheim (DE); Hartmut Hibst, Schriesheim (DE); Berend Eling, Lemfoerde (DE); Jörn Duwenhorst, Lemforde (DE); Richard Riggs, Mannheim (DE); Alexander Traut, Schriesheim (DE); Christof Kujat, Neustadt (DE); Cornelia Röger, Schwetzingen (DE); Christian Krausche, Rudlingen (CH)

(73) Assignee: BASF SE, Ludwigshafen (DE)

(21) Appl. No.: 13/139,463

(22) PCT Filed: Dec. 3, 2009
(86) PCT No.: PCT/EP09/66351

§ 371 Date: Jun. 13, 2011

(30) Foreign Application Priority Data
Dec. 12, 2008 (EP) 08171437.0

(51) Int. Cl. C08K 5/5419; C07F 7/08; G02B 5/22; C09D 5/32; B32B 3/00

(52) U.S. Cl. 524/262; 556/12; 252/589; 428/402

(57) ABSTRACT

Improved metal oxide nanoparticles, in particular zinc oxides, are modified with silanes. The particles obtained in this way are suitable for an improved UV protection of polymers.

The invention relates to functionalized metal oxide particles, to a method of producing them and to their use.

It is already known to provide polymeric materials, such as, for example, polyurethanes or reaction resins, with stabilizers, in order, for example, to improve the UV protection. For example, it is known to incorporate zinc oxide particles for improving the UV protection. According to WO 03/053398, nanoparticulate zinc oxide with a coating of an oligo- or polyethylene glycolic acid is said to offer improved UV protection. According to WO 2004/052327 A2 nanoparticulate zinc oxide surface-modified with an organic acid is said to offer improved UV protection, for example in cosmetic compositions.

According to WO 2004/111136 A1, nanoparticulate zinc oxide is surface-modified with an unsaturated organic acid and used, for example, as UV photoprotective filter. It is known from WO 2007/048570 A2 to use double-layer, surface-modified nanoparticulate zinc oxide for example in sunscreen compositions.

The ZnO particles functionalized with acids have the disadvantage that acid groups react with the ZnO surface to form metal carboxylates which are worn away from the surface. As a result, effective UV protection per Zn used is reduced. Moreover, impurities in Zn carboxylates can have adverse effects in subsequent applications (e.g. they can act as catalysts in polymerization reactions).

According to EP 1 146 069 B1, special multilayer structures consisting of at least one ZnO-containing layer and at least one abrasion-resistant layer are said to have improved properties, with surface-modified nanocrystalline zinc oxide being used. For the ZnO surface functionalization, 3-glycidyloxypropyltrimethoxysilane, for example, is used to give a colorless-milky dispersion/emulsion. This cloudiness is a disadvantage in a number of applications, particularly if high transparency is desired. According to DE 10 2005 010 320 B4 ZnO particles are dispersed in polar-protic solvents and treated with alkoxyalkylsilanes and then treated with UV radiation. The functionalized ZnO particles are said to have improved properties in heterogeneous catalysis and in photovoltaics. However, this functionalization has the disadvantage that relatively energy-consuming UV radiation is required in the process. According to WO 2007/043496 A1 ZnO nanoparticles are modified with thiols or silanes and are said to offer excellent UV protection. The silane used here was phenyltrimethoxysilane in example 3. The functionalized ZnO particles could only be dispersed after a long-term input of energy, but formed no stable suspensions in methanol. Consequently, such functionalized ZnO particles can only be used to a limited extent. Moreover, in the case of the silane-functionalized ZnO particles according to EP 1 146 069 B1, DE 10 2005 010 320 B4 or WO 2007/043496 A1, there is the danger of decomposition of the polymer matrix due to the photocatalytic effect of ZnO.

According to WO 2007/134712, nanoparticles are obtained by reacting precursors with siloxy compounds. The nanoparticles preferably comprise an SiO₂ coating and/or further functionalization, including organofunctional silanes. However, this method has the disadvantage that relatively expensive bases are used here for producing nanoparticles. According to WO 2007/059842 A2, amphiphilic silanes are used for the surface modification of particles, in particular nanoparticles, including oxides and/or hydroxides of titanium, zinc, cerium, which are optionally used with oxides and/or hydroxides of silicon. These amphiphilic silanes have the disadvantage that they have at least one reactive group.

It was therefore the object of the invention to provide improved nanoparticles which are redispersible in various solvents and, moreover, also preferably have a closed Si, Al, or Zr and C-containing coating and are thus exceptionally suitable as UV stabilizers for polymers, paints, finishes or coatings.

The invention relates to metal oxide particles functionalized with a compound F which have an average particle size, measured according to the dynamic light scattering (DLS) method in the nano range, preferably in the range from 10 to 80 nm, in particular 10 nm to 50 nm, wherein the metal of the metal oxide particles is zinc, titanium or cerium or a mixture thereof and F corresponds to the following formula:

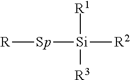

in which

R is R¹⁰O(CH₂CR¹¹R¹²O)ₚ where

p is zero or an integer, in particular 1 to 100, preferably 1 to 30, in particular 5 to 15, where the groups indexed with p can be composed of radicals with differing meanings for R¹¹ and R¹²,

R¹⁰ is C₁-C₄-alkyl, in particular methyl or ethyl; hydrogen

R¹¹; R¹² are identical or different, with the meanings H, alkyl having 1 to 4 carbon atoms, in particular hydrogen, methyl or ethyl

R¹, R², R³ are identical or different, hydrogen or alkoxy, in particular C₁- to C₄-alkyloxy, in particular methoxy or ethyloxy; acyloxy, in particular acetoxy; amino; halogen, in particular CI, where at least one of the groups R², R³ is hydrolysable and in particular is methoxy or ethoxy

Sp is (CH₂)_{q}

q is an integer, in particular 1-10, preferably 1-3.

Functionalization is understood as meaning that the metal oxide particles interact with the compound F. Depending on the type of compound F and the conditions, this can take place, for example, in the form of an adsorption, a coordinative bond or a chemical bond.

The term “metal oxide particles” refers to particles which consist essentially of metal oxide, these particles also being able to have hydroxide groups on their surface, depending on the particular ambient conditions, as is known to the person skilled in the art from the prior art (dissertation, B. Rohe, “Synthese, Charakterisierung und Applikationen von unbeschichteten, silan-beschichteten und UV-modifizierten Nano-Zinkoxiden [Synthesis, Characterization and Applications of uncoated, silane-coated and UV-modified nano-zinc oxides)]”, University of Duisburg-Essen, 2005, pp. 49, 90). In one embodiment, the ZnO particles are therefore ZnO/zinc hydroxide/zinc oxide hydrate particles. Moreover, depending on the nature of the metal precursor used, for example fragments and/or products of the metal precursor may also be found on the metal oxide surface, for example, acetate groups in the case of the use of Zn(OAc)₂ or Zn(OAc)₂ dihydrate for producing zinc oxide.

To determine the particle size of nanoparticulate metal oxide particles, the person skilled in the art has at his disposal a number of different methods which depend on the composition of the particles and can sometimes produce differing results with regard to the particle size. For example, the primary particle size can be determined by measurements using a transmission electron microscope (TEM). For an ideally spherical shape of the nanoparticles, the particle size would correspond to the particle diameter. According to the present invention, the determination takes place by dynamic light scattering (DLS).

The metal oxide particles FM can be doped with foreign atoms, for example, with metal atoms, in particular with Fe²⁺, Fe³⁺, Co²⁺, Co³⁺, Cu²⁺, Al³⁺, In³⁺, Ga³⁺, Ni²⁺, Mg²⁺, V⁵⁺, Cr³⁺, Mn²⁺, Mn⁴⁺, Nb⁵⁺, Mo⁵⁺, Ta⁵⁺, La³⁺, Y³⁺, preferably in an amount of from 10 to 20 000 ppm, particularly preferably from 100 to 10 000 ppm (ppm refers to the number of foreign atoms based on the number of the main metals (Zn, Ti, Ce or their both mechanical mixtures and also chemical mixed oxides). The doping can take place in a manner known per se, e.g. according to the method, known from DE 10 2006 035 136 A1, of atomizing corresponding metal compounds to form an aerosol, reaction at suitable temperatures with oxygen and work-up or according to [Optical Materials, 2007, 30, pp. 314-317] by a coprecipitation and a subsequent thermal treatment of solutions comprising metal oxide precursors and doping metal precursors.

In one preferred embodiment, the compound F corresponds to the formula given above with the proviso that:

q: is 3 and/or

R³¹, R³², R³³: are identical or different, in each case an alkoxy group, in particular methoxy or ethoxy and/or

R: is CH₃O(CH₂CHR¹¹)ₚ-, where R¹¹ is H, CH₃ or C₂H₅ and p is an integer from 1 to 15, with combinations of the preferred embodiments being possible.

Particularly preferred modifying compounds F correspond to the following formulae CH₃O(CH₂CH₂O)₆₋₉(CH₂)₃Si(OMe)₃, CH₃O[CH₂CH(CH₃)O]₁₀(CH₂CH₂O)₅(CH₂)₃Si(OEt)₃, CH₃O[CH₂CH(CH₂CH₃)O]₂[CH₂CH(CH₃)O]₅(CH₂)₃Si(OEt)₃, where Et is in each case ethyl and Me is methyl.

The invention further relates to a method of producing functionalized metal oxide particles, which comprises
i) bringing metal oxide particles in a solvent into contact with a functionalizing compound F, where F has the meaning given above,
ii) reacting the metal oxide particles with F, if appropriate in the presence of water, and if appropriate a base,
iii) if appropriate coating by adding preferably a polysiloxane or waterglass,
iv) if appropriate removing solvents and further auxiliaries.

The functionalization can be carried out in a manner known per se, e.g. in accordance with WO 2007/011980 A2. In one embodiment, the metal oxide particles are brought into contact in powder form with the compound F. In another embodiment, the functionalizing compound F is dissolved or dispersed in a solvent and brought into contact in this form with the metal oxide particles in dry form or in dispersed form. For the functionalization, the metal oxide particles and the functionalizing compound F are mixed in suitable mixing apparatuses, with the application of high shear forces being preferred.

In a further embodiment, metal oxide particles and functionalizing compound F are brought into contact by shaking or stirring.

In one preferred embodiment, the solvents used in the functionalization are good solvents. Preferred solvents have a dielectric constant greater than 5, preferably greater than 10. Particularly preferred polar solvents used are water, alcohols, in particular methanol, ethanol, 1-propanol, 2-propanol, ethers, in particular tetrahydrofuran, or their mixtures. The reaction can take place in one embodiment in the presence of a base (for example an aqueous or alcoholic ammonia solution), an acid (for example hydrochloric acid) or at least one catalyst (for example organotitanium compounds, e.g. tetrabutyl titanate or organotin compounds, e.g. dibutyltin dilaurate), which favor the hydrolysis and/or condensation of F. The metal oxide particles can be functionalized with the compound F alone or with a mixture of the compound F in combination with further customary surface functionalization agents.

Usually, based on the metal oxide, 1 to 60% by weight, preferably 2 to 30% by weight of component F are used. The reaction ii) preferably takes place at 5 to 100° C., in particular 40 to 70° C. over the course of from preferably 6 minutes to 300 hours, in particular up to 72 hours.

The solvents and by-products stated under iv) can be removed, for example, by distillation, filtration (e.g. by nano-, ultra- or micro cross filtration), centrifugation or decantation and/or be replaced by other solvents.

In one further embodiment of the invention, the metal oxide particles further comprise an amorphous silicon-oxygen-, aluminum-oxygen-, or zirconium-oxygen-containing layer or their combination or mixtures, preferably an amorphous SiO₂-, Al₂O₃- or ZrO₂-containing layer or their mixtures, which are applied in step iii).

The coatings can sometimes comprise hydrate or hydroxide groups. Such coatings are generally known to the person skilled in the art (see e.g. U.S. Pat. No. 2,885,366, DE-A-159 29 51, U.S. Pat. No. -4,447,270, EP 449 888 B1) and are obtainable, for example, through deposition of hydrolysable Si-, Al- or Zr-containing precursors. For example, silicates, aluminates or zirconates (e.g. sodium silicate, sodium aluminate or sodium zirconate) or their mixtures are used for this purpose. In addition, acids (e.g. for the SiO₂-containing coating—silicic acids (e.g. orthosilicic acid H₄SiO₄, or its condensation products e.g. disilicic acid H₆Si₂O₇ or polysilicic acids; for the ZrO₂-containing coating—e.g. metazirconic acid H₂ZrO₃ or orthozirconic acid H₄ZrO₄) or hydroxides (e.g. Al(OH)₃) can be used. Moreover, organometallic precursors of Si, Al or Zr or their mixtures can be used which, during the hydrolysis, produce SiO₂-, Al₂O₃- or ZrO₂ or their hydrates or oxyhydroxides. Such precursors are known to the person skilled in the art. To produce an SiO₂-containing layer, tetraalkoxysilanes (Si(OR)₄, e.g. tetramethoxysilane, tetraethoxysilane), for example, are used. To produce an Al₂O₃-containing layer, Al alcoholates (e.g. aluminum isopropylate, aluminum isobutylate), for example, are used. To produce a ZrO₂-containing layer, Zr alcoholates (e.g. zirconium isopropylate, zirconium n-butylate, zirconium isobutylate), for example, are used.

Preferably, an SiO₂-containing layer is applied to the functionalized metal oxide particles. The SiO₂ coating of the metal oxide particles can be carried out in a manner known per se.

In one preferred embodiment, an SiO₂-containing layer according to EP-A 988853 on the metal oxide particles can be obtained by bringing the particles into contact in any desired order with silicic acid, water, an alkali and an organic solvent, preferably at a silicon concentration of from 0.0001 to 5 mol per liter and a ratio of water to organic solvent of from 0.1 to 10, in particular 0.1 to 5.

One such silicic-acid-containing composition can be obtained for example by the action of water, an alkali and an organic solvent on tetraalkoxysilanes. In another embodiment, the silicic acid can be obtained by the action of water-alkali and an organic solvent on silicon tetrahalides and subsequent hydrolysis. The alkalis used in the preparation of the silicic acid are, in particular, ammonia, sodium hydroxide, potassium hydroxide carbonates or organic amines, The organic solvents used for the silicic acid preparation are preferably alcohols such as methanol, ethanol, propanol and pentanol, ether ketones, with ethanol being particularly preferred. In one embodiment, the SiO₂-containing layer can be obtained by immersing the metal oxide particles into the composition comprising silicic acid. The temperature for the deposition of the SiO₂-containing layer is not critical, in one preferred embodiment it is between 10 and 100° C., preferably between 20 and 50° C. The preferred pH depends on the material to be coated. In the case of ZnO, the pH is preferably between 7 and 11.

The SiO₂ coating of metal oxide particles can, for example, be carried out by hydrolysis of tetraalkoxysilanes according to WO 02/22098-A. The deposition of the polysiloxane can take place before, during or after the functionalization.

Preferred polysiloxanes correspond to the following formula)

Si(OR²⁰)₄

in which

R²⁰ is a hydrocarbon radical, preferably an alkyl radical having 1 to 20, in particular 1 to 5 carbon atoms.

Preferred polysiloxanes of this type are pentamethoxysilane, tetraethoxysilane, tetra-n-propoxysilane, tetraisopropoxysilane and tetra-n-butoxysilane.

In a further preferred embodiment, the functionalizing compounds F and/or tetraalkoxysilanes used for the SiO₂ coating are precondensed. Such a precondensation can take place before, during and after the functionalization of the metal oxide particles. In one embodiment of the invention, a precondensation is possible by introducing suitable substituents into the silanes.

In a further preferred embodiment, the functionalization forms, as a result of the reaction of the metal oxide particles with the compound F and together with the SiO₂-containing layer, a closed Si-C-containing layer around the metal oxide particles according to the invention. An Si—C-containing layer is understood here as meaning that silicon and carbon in each case envelope the metal oxide particle in uniform distribution. This closed layer can be measured and detected by means of TEM and EDXS (Energy Dispersive X-ray Spectroscopy).

The disadvantage of the SiO₂ coating known from the prior art is that such particles, upon removing solvents, cannot be redispersed to an average particle size of less than 50 nm, measured according to DLS. The closed Si—C-containing layer according to the invention combines advantages of silane functionalization and an SiO₂ coating. The UV-absorbing particles according to the invention are notable for the fact that they both can be redispersed in various solvents, and have a lower photocatalytic effect.

The invention further relates to a method of producing UV-absorbing metal oxide partides which are redispersible in solvents to an average particle size of less than 50 nm measured by means of DLS and have an Si—C-containing layer measured according to TEM and EDXS, which comprises
i) bringing metal oxide particles in one or more solvents into contact with at least one compound F of the formula given above
ii) reacting the metal oxide particles with the compound F, if appropriate in the presence of water and if appropriate a base, such that a suspension with an average particle size in the nano range, preferably in the range from 10 nm to 80 nm, in particular 10 nm to 50 nm, measured according to DLS, is formed
iii) following with an SiO₂-containing coating by adding an organosilane (including polysiloxane) comprising exclusively hydrolysable group or waterglass or silicic acid, and the average particle size here is in the nano range, preferably in the range from 10 nm to 80 nm, in particular 10 nm to 50 nm, measured according to DLS
(iv) if appropriate removing solvents and further auxiliaries.

UV-absorbing particles with a closed Si-C-containing layer which are redispersible in various solvents to an average particle size (% by volume) of less than 80 nm determined by means of dynamic light scattering are not known from the prior art.

The invention further relates to dispersions of UV-absorbing particles in solvents produced by this method.

The invention further relates to dispersions comprising the metal oxide particles according to the invention as disperse phase, preferably in solvents as continuous phase. Solvents or solvent mixture can be, for example, H₂O, alcohols (e.g. aliphatic alcohols such as methanol, ethanol, isopropanol or aromatic alcohols such as, for example benzyl alcohol), ethers (e.g. dibutyl ether, tetrahydrofuran, dioxane), esters (e.g. ethyl acetate, butyl acetate, propylene glycol methyl ether acetate), ketones (e.g. acetone, methyl ethyl ketone, cyclohexanone), amides (e.g. dimethylformamide, N-methyl-2-pyrrolidone) or hydrocarbons (e.g. n-hexane, cyclohexane, toluene, xylenes).

The solids content of dispersions according to the invention is preferably from 0.1 to 99.9, preferably 1 to 70, particularly preferably 5 to 50% by weight, based on the dispersion.

The dispersions according to the invention can comprise further effect substances in the form of dispersed particles (e.g. SiO₂, ZrO₂), and/or soluble molecules (e.g. UV absorbers, stabilizers, flame retardants, antioxidants, antifogging agents, lubricants, antiblocking agents, organic dyes, IR dyes, fluorescent dyes, lighteners, antistatic agents, biocides, nucleating agents, herbicides, fungicides or pesticides, free-radical scavengers).

Mixtures of the modified dispersions and/or dry residues with further valuable additive materials such as, for example, solutions of organic UV absorbers or stabilizers, flame retardants, are also conceivable. Moreover, modified oxide particles can also be applied prior to application to a carrier (e.g. polymer spheres).

The functionalized metal oxide particles according to the invention are suitable in the form of a dispersion or as powder, in particular for the UV protection of polymers. In one embodiment, the functionalized metal oxide particles are present in polymers themselves and protect these against UV radiation. In another embodiment, the functionalized metal oxide particles are present in a polymer film or in a paint coat, which in turn can be used as UV protection for other materials.

Polymers into which the metal oxide particles according to the invention can be incorporated particularly well are in particular polycarbonate, polyethylene terephthalate, polyamide, polystyrene, polymethyl methacrylate and copolymers and blends of the polymers.

The metal oxide particles according to the invention can be introduced into a polymer for UV protection in a manner known per se, for example using an extruder or kneader. In another embodiment, the polymers may also be dispersions of the polymers, as, for example, in the case of paints or paint preparations. In this case, the incorporation can take place by mixing processes customary per se.

Furthermore, the functionalized metal oxide particles according to the invention and dispersions comprising these are also particularly suitable for the coating of surfaces, for example, made of wood, plastics, fibers or glass, and also for paints, finishes and coatings.

Furthermore, the metal oxide particles and dispersions according to the invention are also suitable for use as UV protection in cosmetic preparations and sunscreen compositions. In this connection they can preferably be used in an amount of from 1 to 50, preferably 5 to 30% by weight, based on the preparation.

### EXAMPLES

Dynamic light scattering (DLS)

The measurements are carried out using an instrument from Malvern Instruments at room temperature. The average particle size is determined according to the volume fraction.

Transmission electron microscopy (TEM)

The TEM investigations were carried out on a Tecnai G2 instrument from FEI with an integrated energy dispersive X-ray spectroscopy (EDXS). The samples were prepared on a perforated C film (Lacey carbon film). The elemental analysis by means of EXDS was carried out at those positions where the film had a hole.

### Example 1

Preparation of ZnO

73.6 g of zinc acetate dihydrate (Chemetall) were suspended in a 42 l flask in 2236 ml of 2-propanol and heated to 75° C. In parallel to this, 32.8 g of potassium hydroxide were dissolved in 1168 ml of 2-propanol at 75° C. The KOH solution was then added to the zinc acetate suspension with vigorous stirring, the resulting mixture was heated for 1 hour at 75° C. with stirring and cooled to room temperature. The resulting white precipitate was settled out overnight, the supernatant was filtered off with suction, and the white residue was washed with 1000 ml of 2-propanol and settled out. Supernatant was again filtered off with suction, the white residue was washed with 2-propanol and settled out. ZnO was then topped up with 2-propanol such that a 2% by weight ZnO dispersion was obtained.

### Example 2

Modification of ZnO with 2-[methoxy(polyethyleneoxy)propyl]trimethoxysilane

A solution of 0.5 g of 2-[methoxy(polyethyleneoxy)propyl]trimethoxysilane (CH₃O(CH₂CH₂O)₆₋₉(CH₂)₃Si(OCH₃)₃, ABCR, CAS 65994-07-2, SIM 6492.7, MW 460-590) in 26 ml of 2-propanol was added dropwise with vigorous stirring over the course of 30 minutes to 100 g of the 2% by weight ZnO suspension prepared according to example 1. The suspension was heated to 60° C. and the mixture was heated under reflux for 30 minutes. Then, 1.7 g of a 25% by weight aqueous NH₃ solution were added and the resulting suspension was heated with stirring for 12 hours at 60° C. The suspension became transparent. 2-Propanol and NH₃ were then removed at 50° C. in a rotary evaporator, until the pressure had a constant value of less than 10 mbar. The white residue was then dried in vacuo <10 mbar for a further 30 minutes (resulting N/Zn ratio <0.2% by weight).

### Example 3

Dispersion comprising ZnO modified with 2-[methoxy(polyethyleneoxy)-propyl]trimethoxysilane in dimethylformamide (DMF)

The white residue of ZnO modified with 2-[methoxy(polyethyleneoxy)-propyl]trimethoxysilane prepared according to example 2 was, following the removal of 2-propanol and NH₃, redispersed in 38 g of DMF. The average particle size determined by means of DLS was 26 nm.

### Example 4

Dispersion comprising ZnO modified with 2-[methoxy(polyethyleneoxy)-propyl]trimethoxysilane in tetrahydrofuran (THF)

The white residue of ZnO modified with 2-[methoxy(polyethyleneoxy)-propyl]trimethoxysilane prepared according to example 2 was, following the removal of 2-propanol and NH₃, redispersed in 38 g of THF. The average particle size determined by means of DLS was 23 nm. The TEM measurement confirmed a primary particle size of ca. 10 nm.

### Example 5

Dispersion comprising ZnO modified with 2-[methoxy(polyethyleneoxy)-propyl]trimethoxysilane in cyclohexanone

The white residue of ZnO modified with 2-[methoxy(polyethyleneoxy)-propyl]trimethoxysilane prepared according to example 2 was, following the removal of 2-propanol and NH₃, redispersed in 38 g of cyclohexanone. The average particle size determined by DLS was 18 nm.

### Example 6

Dispersion comprising ZnO modified with 2-[methoxy(polyethyleneoxy)-propyl]trimethoxysilane in water

The white residue of ZnO modified with 2-[methoxy(polyethyleneoxy)-propyl]trimethoxysilane prepared according to example 2 was, following the removal of 2-propanol and NH₃, redispersed in 38 g of water. The average particle size determined by DLS was 18 nm.

### Example 7

Modification of ZnO with 2-[methoxy(polyethyleneoxy)propyl]trimethoxysilane and a subsequent coating with an SiO₂-containing layer by hydrolysis of tetramethoxysilane

A solution of 0.5 g of 2-[methoxy(polyethyleneoxy)propyl]trimethoxysilane (CH₃O(CH₂CH₂O)₆₋₉(CH₂)₃Si(OCH₃)₃, ABCR, CAS 65994-07-2, SIM 6492.7, MW 460 - 590) in 26 ml of 2-propanol was added dropwise with vigorous stirring over the course of 30 minutes to 100 g of a 2% by weight ZnO suspension prepared according to example 1. The suspension was heated to 60° C. and the mixture was heated under reflux for 30 minutes. 2.5 g of a 25% by weight aqueous NH₃ solution were then added and the resulting suspension was heated with stirring for 1 hour at 60° C.

The suspension became transparent. Furthermore, a solution of 0.25 g of tetramethoxysilane in 25 ml of 2-propanol was added to the resulting suspension with stirring. The suspension obtained was further stirred for one hour at 60° C. 2-propanol and NH₃ were then removed at 50° C. in a rotary evaporator until the pressure had a constant value of <10 mbar. The white residue was then dried in vacuo <10 mbar for a further 30 minutes (resulting N/Zn ratio <0.2% by weight).

### Example 8

Dispersion comprising ZnO modified with 2-[methoxy(polyethyleneoxy)-propyl]trimethoxysilane and then coated with SiO₂ in water

The white residue of ZnO modified with 2-[methoxy(polyethyleneoxy)-propyl]trimethoxysilane prepared according to example 7 was, following the removal of 2-propanol and NH₃, redispersed in 38 g of water. The average particle size determined by means of DLS was 45 nm. The TEM measurement confirmed a primary ZnO particle size of ca. 10 nm. Moreover, by means of energy dispersive X-ray spectroscopy (EDXS), a closed Si/C-containing layer around all of the ZnO particles was detected.

### Example 9

Dispersion comprising ZnO modified with 2-[methoxy(polyethyleneoxy)-propyl]trimethoxysilane and then coated with SiO₂ in cyclohexanone

The white residue of ZnO modified with 2-[methoxy(polyethyleneoxy)-propyl]trimethoxysilane prepared according to example 7 was, following the removal of 2-propanol and NH₃ redispersed in 38 g of cyclohexanone. The average particle size determined by means of DLS was 34 nm.

1.-13. (canceled)

14. Metal oxide particles which have an average particle size, measured according to the dynamic light scattering (DLS) method in the nano range, and functionalized with a compound F, where the metal of the metal oxide particle is cerium, zinc, or a mixture thereof, and wherein the compound F corresponds to the following formula: 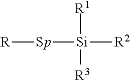
in which
R is R¹⁰O(CH₂CR¹¹R¹²O)ₚ,
p is zero or an integer, where the groups indexed with p can be composed of radicals with differing meanings for R¹¹ and R¹²,
R¹⁰ is C₁-C₄-alkyl,
R¹¹ and R¹² are identical or different, with the meanings H, or alkyl having 1 to 4 carbon atoms,
R¹, R², and R³ are identical or different, with the meanings hydrogen or alkoxy, acyloxy, amino, halogen, where at least one of the groups R¹, R², or R³ is hydrolysable,
Sp is (CH₂)_{q}, and
q is an integer.

15. The metal oxide particles according to claim 14, wherein the average particle size of the particles, measured according to the dynamic light scattering (DLS) method is from 10 nm to 80 nm and
p is zero or an integer up to 100,
R¹⁰ is methyl or ethyl,
R¹¹ and R¹² are identical or different, and are hydrogen, methyl or ethyl,
R¹, R², and R³ are identical or different, with the meanings hydrogen or C₁ to C₄ alkyloxy, acetoxy, amino, or Cl, where at least one of the groups R′, R², or R³ is hydrolysable, and
q is an integer from 1 to 10.

16. The metal oxide particles according to claim 15, wherein
p is an integer from 1 to 30,
R¹, R², and R³ are identical or different, with the meanings hydrogen or methoxy or ethoxy, acetoxy, amino, or Cl, where at least one of the groups R¹, R², or R³ is hydrolysable, and
q is an integer from 1 to 3.

17. The metal oxide particles according to claim 14, doped, in order to reduce the photocatalytic activity, with a Cu, Fe, Co, Ni, Cr, Mn or Ti compound or a mixture thereof in an amount of from 1 to 20 000 ppm, based on the metal oxide.

18. The metal oxide particles according to claim 14, comprising a silicon-oxygen-containing layer which is obtainable through deposition of a tetraalkoxysilane, polysiloxane, silicic acid or alkali metal silicate.

19. The metal oxide particles according to claim 14, comprising an aluminum-oxygen-containing layer which is obtainable through deposition of a hydrolysable Al-containing functionalizing compound.

20. The metal oxide particles according to claim 19, wherein the hydrolysable Al-containing functionalizing compound is an aluminum alcoholate or aluminum chloride.

21. The metal oxide particles according to claim 14, comprising a zirconium-oxygen-containing layer which is obtainable through deposition of a hydrolysable Zr-containing functionalizing compound.

22. The metal oxide particles according to claim 21, wherein the hydrolysable Zr-containing functionalizing compound is zirconium alcoholate or zirconium chloride.

22. The metal oxide particles according to claim 14, wherein the functionalizing compound is precondensed.

23. A dispersion comprising metal oxide particles according to claim 14 as disperse phase.

24. The dispersion according to claim 23, wherein the particle size of the functionalized metal oxide particles has an average value, measured according to the dynamic light scattering method (DLS) in the range from 10 nm to 80 nm.

25. The dispersion according to claim 23, wherein the particle size of the functionalized metal oxide particles has an average value, measured according to the dynamic light scattering method (DLS) in the range from 10 nm to 50 nm.

26. The dispersion according to claim 23, wherein the functionalized metal oxide particles have an average size, measured according to DLS in the nano range, and are coated with a closed Si—C-containing layer measured according to TEM and EDXS (Energy Dispersive X-ray Spectroscopy).

27. The dispersion according to claim 26, wherein the functionalized metal oxide particles have an average size, measured according to the dynamic light scattering method (DLS) in the range from 10 nm to 80 nm.

28. The dispersion according to claim 26, wherein the functionalized metal oxide particles have an average size, measured according to the dynamic light scattering method (DLS) in the range from 10 to 50 nm.

29. A method of producing functionalized metal oxide particles or dispersions comprising functionalized metal oxide particles according to claim 14, which comprises
i) bringing the metal oxide particles in at least one solvent into contact with a compound F of the formula given in claim 14, or with its precondensed form,
(ii) reacting the metal oxide particles with F, optionally in the presence of water,
iii) optionally coating the particles by adding a tetraalkoxysilane, polysiloxane, silicic acid or alkali metal silicate, and optionally
iv) removing solvents and further auxiliaries.

30. The method according to claim 29, wherein, following the reaction with the functionalizing compound F, the functionalized metal oxide particles are provided with an SiO₂ coating by adding tetramethoxysilane, precondensed tetramethoxysilane, tetraethoxysilane, precondensed tetraethoxysilane and/or an alkali metal silicate and optionally hydrolysis.

31. The method according to claim 29, wherein the solvent and optionally further auxiliaries are removed.

32. A method for stabilizing a polymer, a paint, a finish or a coating, comprising adding metal oxide particles according to claim 14 to the polymer, paint, finish or coating.
